(19) United States
(12) Patent Application Publication
(10) Pub. No.: US 2018/0150852 A1
(43) Pub. Date: May 31, 2018

(54) METHOD, SYSTEM AND PROGRAM PRODUCT FOR REPRESENTING RELATIONSHIPS BETWEEN A COMPANY AND ITS STAKEHOLDERS

(71) Applicant: Luca POMA, Torino (IT)

(72) Inventor: Luca POMA, Torino (IT)

(21) Appl. No.: 15/363,586

(22) Filed: Nov. 29, 2016

(51) Int. Cl. G06Q 30/02; G06T 11/20; G06F 15/02

(52) U.S. Cl. CPC G06Q 30/0201; G06F 15/02; G06T 11/206

(57) ABSTRACT

A method, a system and a program product for representing relationships between a company and its stakeholders are described. Information representative of the CSR of a company and information representative of a stakeholder are acquired by an electronic calculator. On the basis of the information representative of each stakeholder, the electronic calculator generates a map representing the relationships data between the company and its stakeholder, defining on the map a Cartesian graph comprising a first X-axis and a second Y-axis, the first X-Axis of the Cartesian graph being representative of the influence of a stakeholder on the company, the second Y-Axis of the Cartesian graph being representative of the influence of the company on the stakeholders.

### FIELD OF THE DISCLOSURE

The present disclosure relates to managing stakeholder relationships, particularly, to a method, system and program product for representing relationships between a company and its stakeholders.

### BACKGROUND

Nowadays, companies are highly interconnected to the environment surrounding them. Thus, they are invested with new responsibilities that cannot ignore if they wish to maintain a high competitiveness on the market.

Such an environment is represented by the so-called stakeholders and the relationships of the company with them.

The relationships between a company and its stakeholders may include external relationships and internal relationships. Examples of external relationships include the relationships of the company with customers, shareholders, suppliers, distribution partners, financiers, the wider community and so on. Examples of internal relationships include the relationships of the company with employees, workgroups, functional areas, departments, and so on.

The stakeholders are affected by and can affect a company and therefore they must be recognized and managed accordingly.

In this regard, methods for representing or mapping a network of stakeholders are known in the art in which, typically, the company is represented in the center of a map, as the hub to which the related stakeholders are linked. This type of representation goes beyond the merely graphic denoting actually the way in which it is perceivable the role of the company and through which the company relates to its stakeholders around it.

The representing or mapping of stakeholders traditionally used a binary logic, i.e. a logic that a statement is either true or false. According to this approach, an entity reported is a stakeholder (statement=true) or not (statement=false).

It is evident that a method for representing stakeholder based on that approach merely provides a list of stakeholders graphically represented, i.e. such method is limited, not flexible and it does not provide any additional information relating the relationship between the company and the stakeholders.

Alternatively, an improved method for representing or mapping stakeholders can be based on the Fuzzy logic approach.

The so-called Fuzzy logic defines and uses the concept of logic with “infinite values of truth”, in which each a statement can be associated with a variable grade of truth having a value in the range comprised between the value 0 and the value 1.

According to the Fuzzy logic, an entity, in addition to being true (i.e. with a statement corresponding to value 1) or false (i.e. with a statement corresponding to value 0), as required by the binary logic, can also be represented with intermediate values between the value 0 and the value 1.

A method for representing or mapping stakeholders based on the Fuzzy logic approach is able to highlight with a vector line of a specific length the connection between a company and each stakeholder. The length of the vector line connecting the company with a stakeholder is directly proportional to the level of engagement between the company and the stakeholder, i.e. the length of the vector line is directly proportional to the amount of the attention to which the stakeholder is accustomed to receiving.

In addition, a color-coding scheme associated to each stakeholder indicates the approaching of a crisis situation for such stakeholder (e.g. green, relationships/situation under control—good dialogue; yellow, relationship/situation requiring attention—dialogue should be intensified; red, potential crisis—almost no dialogue).

Notwithstanding it provides additional information relating the relationship between a company and its stakeholder, the method for representing stakeholders based on the Fuzzy logic approach is in any case not flexible and it only provides approximate information which are not able to represent a realistic relationship between a company and its stakeholders, as necessarily asked today by a company having the need to maintain a high competitiveness with respect to its competitors.

### SUMMARY OF THE INVENTION

According to some aspects of the present description, a method for representing relationships data between a company and its stakeholders is provided, with allows to overcame the drawbacks mentioned above with reference to the cited prior art and particular which is able to provide more complete, realistic and therefore useful information relating the relationships between a company and its stakeholders.

According to a first aspect, there is provided a method for representing relationships between a company and its stakeholders, comprising steps of: acquiring, by an electronic calculator, information representative of a stakeholder; generating, by the electronic calculator, on the basis of the information representative of each stakeholder, a map representing the relationships data between the company and its stakeholder, said step of generating further comprises a step of defining on the map a Cartesian graph comprising a first X-axis and a second Y-axis, the first X-Axis of the Cartesian graph being representative of the influence of a stakeholders on the company, the second Y-Axis of the Cartesian graph being representative of the influence of the company on the stakeholders.

According to a second aspect, there is provided a program product loadable in a memory unit of an electronic calculator.

The program product can be executed by a data processing unit of the electronic calculator to perform steps of: acquiring information representative of a stakeholder; generating, on the basis of the information representative of the company and the information representative of each stakeholder, a map representing the relationships data between the company and its stakeholder, the step of generating further comprising a step of defining on the map a Cartesian graph comprising a first X-axis and a second Y-axis, the first X-Axis of the Cartesian graph being representative of the influence of a stakeholders on the company, the second Y-Axis of the Cartesian graph is representative of the influence of the company on the stakeholders.

According to a third aspect, there is provided a system for representing relationships between a company and its stakeholders, comprising: an electronic calculator having a data processing unit and a memory unit operatively connected to the data processing unit; at least an additional electronic calculator operatively connected to the electronic calculator by a communication network.

The electronic calculator is configured to perform the steps of: acquiring information representative of a stakeholder; generating, on the basis of the information representative of the company and the information representative of each stakeholder, a map representing the relationships data between the company and its stakeholder, said step of generating further comprises a step of defining on the map a Cartesian graph comprising a first X-axis and a second Y-axis, the first X-Axis of the Cartesian graph being representative of the influence of a stakeholders on the company, the second Y-Axis of the Cartesian graph being representative of the influence of the company on the stakeholders.

Further aspects are provided in the description, drawings and claims of the present application.

### BRIEF DESCRIPTION OF THE DRAWINGS

Further features and advantages of the method and system according to the present disclosure will appear more clearly from the following description of preferred embodiments thereof, given by way of a non-limiting example with reference to the annexed figures, wherein:

FIG. 1 shows a schematic view of a system for representing relationships data between a company and its stakeholders according to an embodiment of the disclosure.

FIG. 2 shows a block diagram of a method for representing relationships data between a company and its stakeholders according to an embodiment of the disclosure.

FIG. 3 shows a map representing of relationships data between a company and its stakeholder obtainable with the method according to the present disclosure.

### DETAILED DESCRIPTION OF THE PREFERRED EMBODIMENTS

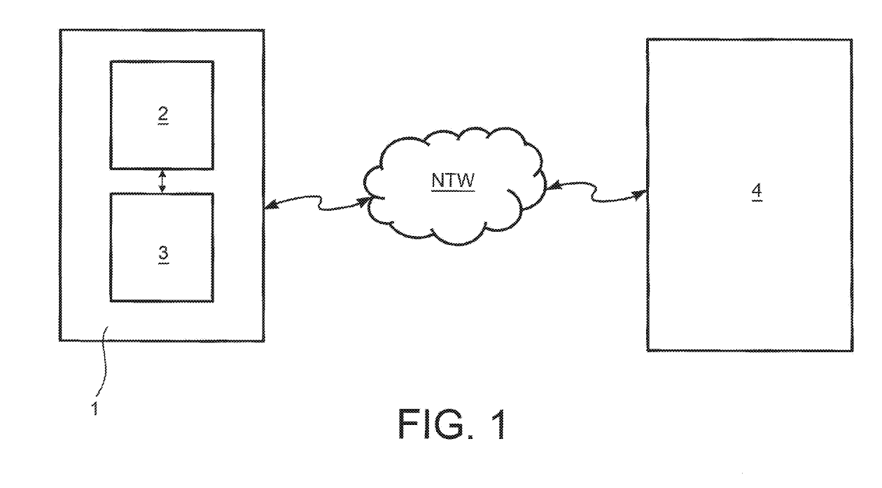

With reference to the embodiment of FIG. 1, a system 100 for representing relationships data between a company and its stakeholders, hereinafter also referred to simply as system 100, is now described.

First of all, before proceedings with the description of the system 100 of the present disclosure, it should be noted that the Applicant, alternatively to or in combination with an approach based on fuzzy logic, has observed that systems and methods for representing or mapping relationships data between a company and its stakeholders may be developed with an approach based on the concept of neural network.

A neural network is an adaptive system which is able to change its structure on the basis of the information processed by the neural network itself.

Therefore, mathematical models calculating these adaptive skills are used to solve problems of artificial intelligence in various domain.

The Applicant applied these mathematical models to Corporate Social Responsibility (CSR) developing the system, the method and the corresponding program product according to the embodiments of the present disclosure.

In fact, the information (i.e. a signal) flowing in a neural network (i.e. a brain) are multidirectional: they can be sent and received within a single neuron, between two neurons in the same layer, or between different layers of neurons.

Likewise, the same effect may be found in the CSR, i.e. the flow of information in CSR is multidirectional: stakeholders restructure themselves in response to inputs from the company, which affect the stakeholder's asset and the scenario that the stakeholder is comparing.

Then, in the method (and system) for representing relationships between a company and its stakeholders according to the present disclosure, a good practice will be adopted from a neural network to become a new reference value.

Therefore, the two-dimensional map of stakeholders should be replaced with a graphical representation of a neural network, i.e. a model able to show the relationships (interactions) between a company and its stakeholders, or parties interested in it. In fact, inputs into the neural network (stakeholders) further propagate the signal, thereby enabling the learning of the whole neural network, as can be demonstrated.

Furthermore, it should be noted that to better measure the influence of a stakeholder on a company and vice versa, the Applicant firstly proposed maps of stakeholders using Cartesian coordinates, wherein the first X-axis represents the influence of a stakeholder on the company and the second Y-Axis represents the influence of the company on a stakeholder.

Moreover, in order to obtain the corrected information to correctly position stakeholders on the map, avoiding that these information was somewhat subjective because obtained from an internal reviews of the practice of a company, the Applicant developed a univocal and personalized reference tools enabling comparison of sustainability performance among similarly companies.

These tools advantageously provide a standard basis rendering the method for representing relationships between a company and its stakeholders, on a map with Cartesian coordinates, which is reproducible.

In this regard, according to an embodiment of the disclosure, the Applicant developed an evaluation test and checklist for each stakeholder, which is customized for each stakeholder category.

According to another embodiment of the disclosure, to be considered in combination to previous one, the Applicant developed also a form which can be filled out by a company providing an initial overview of the current CSR policy of the company.

Both said checklist and said form (to be eventually used) will be described later in detail with examples the Applicant.

Returning back to the system 100 of FIG. 1, it comprises an electronic calculator 1, i.e. a server computer.

The electronic calculator 1 comprises a data processing unit 2, e.g. a microprocessor or a microcontroller, and a memory unit 3 operatively connected to the data processing unit 2.

According to an embodiment, the memory unit 3 is internal to the data processing unit 2. According to another embodiment, the memory unit 3 can be external to the data processing unit 2.

The memory unit 2 is configured to store a program product (e.g. a program code) to be executed by the data processing unit 2 to perform the method for representing relationships between a company and its stakeholder, according to the present disclosure.

The memory unit 3 is also configured to store data managed by the data processing unit 2 during the execution of the method.

The electronic calculator 1 comprises a keyboard, a mouse, a display and/or a touch screen interface (not shown in the figure) configured to allow a user to interact with the electronic calculator 1.

The system 100 of the embodiment of FIG. 1 further comprises at least an additional electronic calculator 4, e.g. a client computer (personal computer, notebook, tablet, and so on), operatively connected to the electronic calculator 1, by a communication network NTW, e.g. a wired communication network or a wireless communication network, for example Internet.

The at least an additional electronic calculator 4 comprises the same hardware elements previously described with reference to the electronic calculator 1.

However, the data processing unit of the additional electronic calculator 4 is configured to allow a user to perform filling the form and/or the checklist, previously introduced and in detail described later.

The data processing unit of said at least an additional electronic calculator 4 is configured to send to the electronic calculator 1, by the communication network NTW, data representative of the information collected in the form and/or in the checklist.

The user of the at least an additional electronic calculator 4 can be, for example, the manager of an area of the company to which the subject of the analysis is referred to, the group representing the employees/managers, and either the group representing the specific stakeholder or the CSR manager and/or external consultant.

According to a further embodiment of the system 100 (not shown in the figure), the system 100, other than the electronic calculator 1 and the at least an additional electronic calculator 4, can comprise a plurality of additional electronic calculator, each of them analogous to the additional electronic calculator 4, previously described.

In such an embodiment, each additional electronic calculator of said plurality is associated to a user which can use the corresponding electronic calculator to fill the checklist and/or the form (if available or requested).

According to a further embodiment, not shown in the figures, the at least an additional calculator 4 can correspond to the electronic calculator 1.

In other words, a user entrusted with the filling of the checklist and/or the form (if requested) performs such activity directly on the electronic calculator 1.

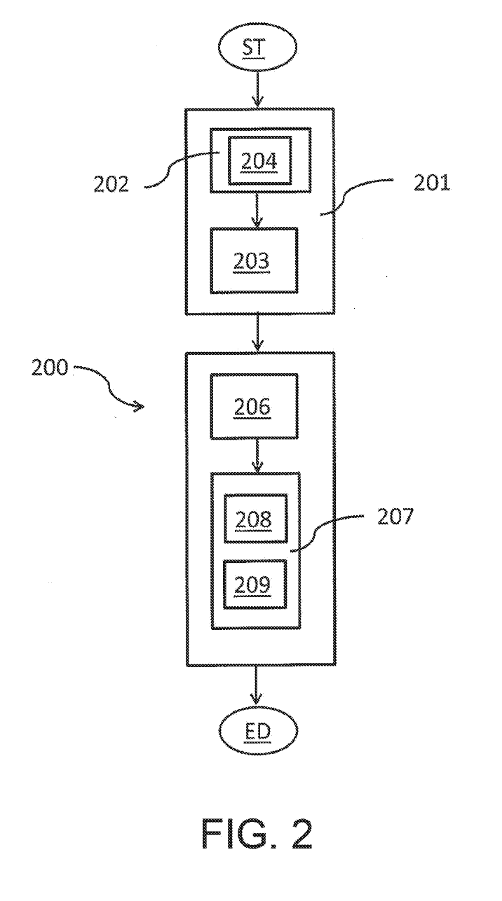

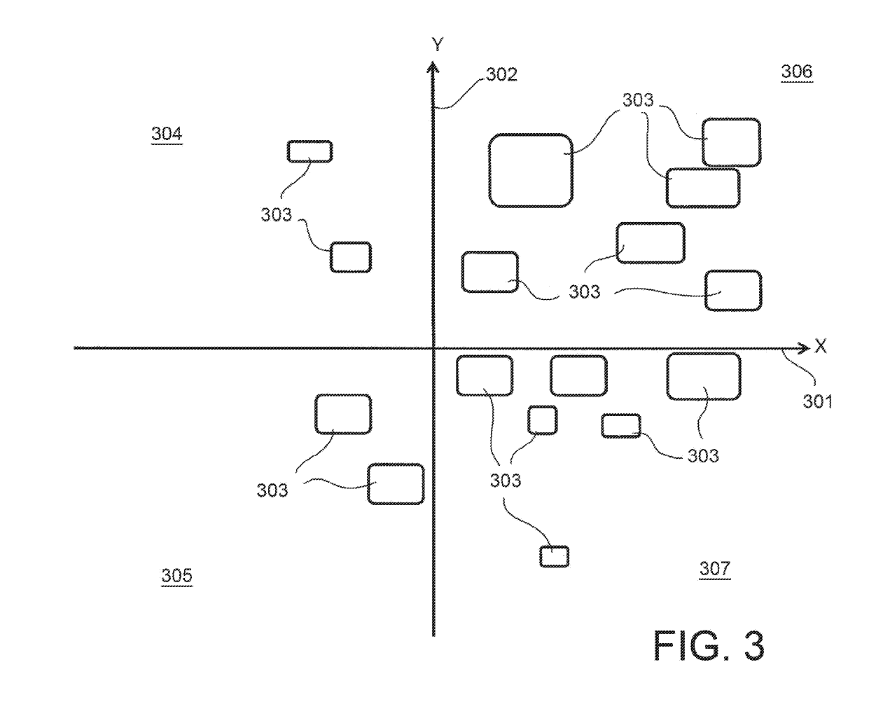

With reference now to FIG. 1, the block diagram of FIG. 2 and the illustration of FIG. 3, a method 200 for representing relationships between a company and its stakeholders, in the following also simply method 200, according to an embodiment of the present disclosure, is now described.

The method 200 comprises a symbolic step of start ST.

The method 200 further comprises a step of acquiring 201, by an electronic calculator 1, information representative of a stakeholder.

In a greater detail, such step of acquiring 201 comprises a step of entering 202, in at least an additional electronic calculator 4 operatively connected to the electronic calculator 1, the information representative of a stakeholder of the company.

Furthermore, the step of acquiring 201 further comprises a step of sending 203, by the at least an additional electronic calculator 4, the information representative of a stakeholder to the electronic calculator 1.

It should be observed that the step of entering 202 comprises a step of filling 204, by a user, an evaluation and test checklist applied to the stakeholder, to be provided to the at least an additional electronic calculator 4, with the information representative of the stakeholder.

According to the present disclosure, an evaluation and test checklist of a stakeholder, in the following simply checklist of a stakeholder, comprises at least three sections.

A first section A comprises information representative of the influence of the stakeholder over the company. A second section B comprises information representative of the influence of the company over the stakeholder. A third section C comprises information representative of the stakeholder engagement.

An example of the first section A of the checklist of the stakeholder, in the case the stakeholder is a client of the company, can be as follows:

A1 performs internal studies on customer satisfaction;

A2 implements quality control for sale channels, for public relations with stakeholders, and for managing relationships with clients before sales (promotion, sales-agents), during sales (sale channels: shops, telephone channels, e-commerce, and so on), and after sales (assistance, follow up, CRM—Customer Relationship Management, and so on);

A3 organizes expert reviews of the sales network and/or retailers to analyse results on customer perception and satisfaction, requests, critical situations and so on;

A4 ranks the company's reputation in terms of the quality of its relationships with client according to the following scale: “best in class”, a “follower” (implementing the best practices adopted by other companies), “indifferent”, or “worst in class”;

A5 ranks the company's ability to manage tensions related to the stakeholder, by using crisis management tools;

A6 Based on the scale below, scores the company according to the number of crisis that it has dealt with in the past 5 years:
more than seven crises: −2.0;
between four and seven crises: −1.0;
two or three crises: 0;
one crises: 1.0;
no crises: 2.0.

An example of the second section B of the checklist of the stakeholder, in the case the stakeholder is a client of the company, can be as follows:

B1 adopts quality certification (ISO 9000, product certificate and so on);

B2 adopts product-safety certification;

B3 adopts ecological/green certification;

B4 divulgates document quality certificates

B5 divulgates information on labelling and/or social certification;

B6 provides information on the product/service in terms of quality, safety, ethics, environmental impact (e.g. detailed information on product origin, traceability, labelling, seals, ISO 22000 and so on).

An example of the third section C of the checklist of the stakeholder, in the case the stakeholder is a client of the company, can be as follows:

C1 emphasizes customer relationship management (CRM) policies, based on dialogue with, and input from, clients on product development and management;

C2 involves clients in the conception and development of new products;

C3 participates in online brand communities and in special events (e.g. openings, temporary shops, and exhibitions);

C4 organizes, and participates in, educational activities, on correct use of products, on not wasting resources and raw material, and on the ethics of the origin of these resources;

C5 adopts policies on shared-pricing and on low-cost product stocks;

C6 divulgates activities addressed to clients (through institutional channels and sustainability reports).

It should be noted that also each answer to the questions of the checklist is a numeric value of a scale of values limited among a minimum value and a maximum value. As an example, the minimum value (e.g. “zero”) is representative of an answer as “null/no/I'm not aware”. On the contrary, the maximum value (corresponding to a full-scale value), as an example 5 or 10, is representative of an answer as “totally/yes/I'm aware”.

In addition, it should be observed that the step of filling 204 the checklist of a stakeholder may be manually performed by the user with the assistance of a CSR staff member of the company or simply using written guidelines on how to fill the checklist of a stakeholder (e.g. indication and meaning of the scale of values, and so on).

Turning to the embodiment of FIG. 2, the method 200 further comprises a step of generating 205, by the electronic calculator 1, on the basis of the information representative of each stakeholder, a map 300 representing the relationships data between the company and its stakeholder.

In greater detail, the step of generating 205 further comprises a step of defining 206 on the map 300 a Cartesian graph comprising a first X-axis 301 and a second Y-axis 302.

The first X-Axis 301 of the Cartesian graph is representative of the influence of a stakeholders on the company. The influence of the stakeholders on the company increases in the direction indicated by the arrow of the first X-Axis 301.

The second Y-Axis 302 of the Cartesian graph is representative of the influence of the company on the stakeholders. The influence of the company on the stakeholders increases in the direction indicated by the arrow of the second Y-Axis 302.

In addition, with reference again to the embodiment of FIG. 2, the step of generating 205 further comprises a step of positioning 207 on the map, by the electronic calculator 1, on the basis of the information representative of each stakeholder, a plurality of icon 303, each of them being corresponding to a stakeholder.

Furthermore, the step of positioning 207 comprises a step of sizing 208, by the electronic calculator 1, each icon of the plurality of icon 303 on the basis of information representative of each stakeholder, respectively.

It should be noted that the size of an icon is directly proportional to the importance perceived by the company of the stakeholder corresponding to said icon.

In addition, the step of positioning 207 comprises a step of associating 209 to each icon, by the electronic calculator, a graphic feature (e.g. a colour, a graphic design, and so on) corresponding to a level of potential crisis in the relationship between the company and the stakeholder corresponding to said icon.

In this regard, with reference in particular to the map of FIG. 3, the first X-Axis and the second Y-Axis divided the map into four quadrants, each of them corresponding a level of potential crises.

According to the map of FIG. 3, considering that the first X-Axis 301 of the Cartesian graph has the arrow from left to right and the second Y-Axis 302 has the arrow from the bottom to the top, a first quadrant 304 (top corner on the left) corresponds to relationships between a company and its stakeholders in which the interest of the company for a stakeholder represented in the first quadrant 304 is dominate, a second quadrant 305 (low corner on the left) corresponds to relationships between a company and its stakeholders in which the interest of the company for the stakeholder represented in the second quadrant 305 is indifferent, a third quadrant 306 (high corner on the right) corresponds to relationships between a company and its stakeholders in which the company and the stakeholder represented in the third quadrant 306 shares interests, a fourth quadrant 307 (low corner on the right) corresponds to relationships between a company and its stakeholders in which the company and a stakeholder represented in the fourth quadrant 306 have not interests in common (i.e. potential crisis).

From a computational point of view, it should be noted that the position, the size of the icon and the graphic feature to be associated to the icon, for each stakeholder, are calculated, by the electronic calculator, on the basis on the numerical values of each answers provided by the user to fill the checklist of the stakeholder.

In particular, in order to calculate the position, the size of the icon and the graphic feature to be associated to the icon, for each stakeholder, a mathematical model is applied.

The mathematical model, for each stakeholder, calculates the average value of the values representing the answers provided for each section (e.g. A, B and C) of the checklist.

In particular, the answers provided for each section contribute, with different percentage, to the calculation of the position, the size of the icon and the graphic feature to be associated to the icon, for each stakeholder. Also the difference between the average values of the answers of the questioned samples contribute to the calculation of position, size and graphic feature for each icon representing a stakeholder.

As an example, in the case the average value calculated for a sample of stakeholder is greater, for a percentage of at least 30%, than the average values calculated on the basis of the answers provided by a sample of employees (of the company) having relationship with the same stakeholder, the level of potential crisis in the relationship of the company with such stakeholder, with reference to a scale of values of potential crisis, increases, i.e. a strong difference is present between the perception of the stakeholder by the company and the perception the stakeholder things to have in the company, and so on.

According to a further embodiment, not shown in the figures, the method 200 can comprise a step of acquiring, by the electronic calculator 1, information representative of the CSR of a company.

In particular, said step of acquiring information representative of the CSR of a company further comprises a step of entering, in at least an additional electronic calculator 4 operatively connected to the electronic calculator 1, the information representative of the CSR policy of a company.

Furthermore, the step of acquiring information representative of the CSR of a company further comprises a step of sending, by the at least an additional electronic calculator 4, the information representative of the CSR policy of a company to the electronic calculator 1.

According to an embodiment, not shown in the figures, it should be noted that the step of entering comprises a step of filling a form, by a user, to be provided to the at least an additional electronic calculator 4, with the information representative of the CSR policy of the company.

It should to be observed that the form to be filled comprises a set of questions each relating to one relationship of the company with a stakeholder. As an example, the answer to each question is a numeric value of a scale of values limited among a minimum value and a maximum value. The minimum value, as an example “zero”, is representative of an answer as “null/no/I'm not aware of such a relationship”. The maximum value (corresponding to a full-scale value), as an example 5 or 10, is representative of an answer as “totally/yes/I'm aware of such a relationship”.

Turning to the embodiment of FIG. 2, the method 200 ends with a symbolic step of end ED.

According to a further embodiment of the disclosure, a program product can be loaded in the memory unit 3 of the electronic calculator 1.

The program product can be executed by the data processing unit 2 of the electronic calculator 1 to perform the following steps:

acquiring 201 information representative of a stakeholder;

generating 205, on the basis of the information representative of each stakeholder, a map 300 representing the relationships data between the company and its stakeholder, generating 205 further comprising a step of defining 206 on the map 300 a Cartesian graph comprising a first X-axis 301 and a second Y-axis 302, the first X-Axis 301 of the Cartesian graph being representative of the influence of a stakeholders on the company, the second Y-Axis 302 of the Cartesian graph is representative of the influence of the company on the stakeholders.

The program product can be executed by the data processing unit 2 of the electronic calculator 1 to perform also, in the step of generating 205, a step of positioning 207 on the map, on the basis of the information representative of each stakeholder, a plurality of icon 303, each of them being corresponding to a stakeholder.

Furthermore, the program product can be executed by the data processing unit 2 of the electronic calculator 1 to perform also, in the step of positioning 205, a step of sizing 208 each icon of the plurality of icon 303 on the basis of information representative of each stakeholder, respectively.

It should be noted that the size of an icon is directly proportional to the importance perceived by the company of the stakeholder corresponding to said icon.

In addition, the program product can be executed by the data processing unit 2 of the electronic calculator 1 to perform also, in the step of positioning 207, a step of associating 209 to each icon a graphic element (e.g. a colour, a symbol, and so on) corresponding to a level of potential crisis in the relationship between the company and the stakeholder corresponding to said icon.

As above indicated the program product previously described is executable by the data processing unit 2 of the electronic calculator 1.

In view of this, according to the embodiment of FIG. 1, the electronic calculator 1 of the system 100 is configured to perform the steps previously described as performed by the product program.

The method for representing relationships data between a company and its stakeholder according to the present disclosure has several advantages and applications.

On the basis of the information representative of each stakeholder, acquired from the evaluation and test checklists duly filled, the results obtained for each of the following three categories—management, employees, stakeholders/CSR manager/external consultant—allow to ascertain the difference between the perception of each of the three categories with respect to the relationship of the company with a stakeholder. A gap between the results provided by a category, more than 30% with respect the results provided by another category, will be evaluated as an indicator of critical issues to be examined, and that will contribute to the definition of potential state of crisis between the company and a stakeholder.

Once successfully positioning the stakeholders of a company in the map, the company will be able to consciously identify one of the following development steps: a) no involvement, b) exploratory, c) developed, d) integrated, e) strategic.

In addition, the map can be confronted with a “target” map getting feedback to align business strategy with the expectations of our internal and external stakeholders through the adoption of appropriate responses to the needs arisen during the audit process and mapping.

Today a company communicates simultaneously with a large number of different audiences at the same times. It is natural to produce different narrative content, form, and tools used for this dialogue. Representing or mapping relationships data between a company and its stakeholders should be preparatory to reporting not only in the social but also the structuring of communication strategies and customized dialogue with various audiences.

In addition, the method of the disclosure may be standardized and this allows to apply the same method to any kind of company/institution/organization, using objective criterias and obtaining an evaluation of the relative network of stakeholders which is advantageously reproducible, comparable, repeatable and controllable.

In other words, the fact that the method is objective allows to confer extremely realistic value of the position, the size and the graphic feature to be associated to each icon of a stakeholder, representing the level of potential crisis in a relationship between a company and each stakeholders. This is due to the plurality of questioned samples of stakeholders for mapping the relationship between a company and its stakeholders and, in addition, to the comparison and the adjustment of the results of each of the survey.

Furthermore, the map obtained with the method of the disclosure may be employed with the results provided by the instruments and/or methods of “crisis management”, associating, to the results of a survey, also a value, for example represented with a specific color (green: no crisis is expected; red: crisis expected; black: crisis in progress).

Moreover, the method of the disclosure is repeatable over time, in order to obtain an objective evaluation of the periodic evolution (every month, every year, at the end of a specific project) of the relationships of the company with one or more of its stakeholders.

As a specific application, the method of the disclosure may be applied to obtain a continuously updated integrated balance sheet of the stakeholders of a company.

Once a relationship between a company and its stakeholders has been defined and represented, it is necessary to process specific communication and interrelationship strategies for each stakeholder. In order to do so, updated and truthful data about each corporate project, the trend of each division, the general progress of the corporate business, and so on, have to be available.

The companies trend to adjust their reporting on the basis of the relationship with their stakeholders, but doing so data on the basis of which the strategies about the relationship with the stakeholders are processed are unavoidably distorted.

The method and the system according to the present invention make available a disintermediated integrated reporting computing tool, i.e. a computing tool wherein reporting data are not mediated by the company (stakeholder->company->integrated balance) but they are inputted directly by the stakeholders into the web platform (stakeholder->integrated balance). This avoids to make available not-genuine reporting which can render the scenario not truth, and allows the company and the community of its stakeholders to have a real time updated set of data (each week, each month, or longer time period) which can be useful to focus the real condition of business of the company and of all the project promoted or funded by the company itself, according to a criteria of absolute authenticity.

A dashboard of indicators comprises a back office which is available by each stakeholder without requesting any permission to the company, directly updating the data of its expertise and also correcting how is affirmed by the company, if needed, in order to arrive to a truthful description of the relationship between the stakeholder itself and the company. A computer program of the back office directly publishes, on the web platform of the integrated reporting, the data (i.e. a) table(s), b) infographics, c) descriptive portions of a project, without the company can/have to alter the data themselves.

Any balance sheet can be designed with a plurality reading paths (e.g. 8, 4 based on the amount of time to be dedicated to the learning, and 4 based in different professional interests).

Enhanced internal search engine can be used.

Reading selections based of grouping of topics is available, with access to content by way of keyword clouds.

In addition, accounting spreadsheet (e.g. in XBRL format) are available, to facilitate a user in the comparisons of a company with ones of the same size.

Furthermore, the infographics on a map may be interactive and dynamic.

In the case a user of the balance sheet updates a chart related to his/her function from the back office, the related information in the infographic is automatically updated as well, guaranteeing that all occurs “in real time”.

Moreover, the access to a balance sheet may be available from any electronic portable devices (e.g. smartphones, tablets and so on).

Share center on every page is available, to simplify sharing on social networks.

In addition, by signing up to receive news feeds on the home page generating the updated integrated balance sheets, a user may be informed of all developments in real time.

Online satisfaction questionnaire to be filled out are available in order to allow to obtain a feedback about the quality of a balance sheet.

The disintermediated integrated reporting computing tool, which is on-line, in real time and transparent, allows to increase the set of available data for determining the exact position of the stakeholder on the map and for completely justifying the condition of the relationship between the stakeholder and the company.

A man skilled in the art may make several changes, adjustments and replacements of elements with other functionality equivalent ones to the embodiments of the method, system and program product for representing relationships data between a company and its stakeholders described above in order to meet incidental needs, without departing from the scope of the following claims. Each of the features described as belonging to a possible embodiment can be obtained independently of the other embodiments described.

1. A method for representing relationships between a company and its stakeholders, comprising steps of:
acquiring, by an electronic calculator, information representative of a stakeholder;
generating, by the electronic calculator, on the basis of the information representative of each stakeholder, a map representing the relationships data between the company and its stakeholder, said step of generating further comprises a step of defining on the map a Cartesian graph comprising a first X-axis and a second Y-axis, the first X-Axis of the Cartesian graph being representative of the influence of a stakeholders on the company, the second Y-Axis of the Cartesian graph being representative of the influence of the company on the stakeholders.

2. The method of claim 1, wherein the step of acquiring information representative of a stakeholder comprises a step of entering, in at least an additional electronic calculator operatively connected to the electronic calculator, the information representative of a stakeholder of the company.

3. The method of claim 2, wherein the step of acquiring information representative of a stakeholder further comprises a step of sending, by the at least an additional electronic calculator, the information representative of a stakeholder to the electronic calculator.

4. The method of claim 2, wherein the step of entering comprises a step of filling, by a user, an evaluation and test checklist applied to the stakeholder, to be provided to the at least an additional electronic calculator, with the information representative of the stakeholder.

5. The method of claim 4, wherein the evaluation and test checklist of a stakeholder comprises at least a first section comprising information representative the influence of the stakeholder over the company, a second section comprises information representative the influence of the company over the stakeholder, a third section comprising information representative of the stakeholder engagement.

6. The method of claim 1, wherein the step of generating further comprises a step of positioning on the map, by the electronic calculator, on the basis of the information representative of each stakeholder, a plurality of icon, each of them being corresponding to a stakeholder.

7. The method of claim 6, wherein the step of positioning comprises a step of sizing, by the electronic calculator, each icon of the plurality of icon on the basis of information representative of each stakeholder, respectively.

8. The method of claim 6, wherein the step of positioning comprises a step of associating to each icon, by the electronic calculator, a graphic element corresponding to a level of potential crisis in the relationship between the company and the stakeholder corresponding to said icon.

9. The method of claim 1, further wherein the step of acquiring, by the electronic calculator, information representative of the CSR of a company.

10. The method of claim 9, wherein the step of acquiring information representative of the CSR of a company further comprises a step of entering, in at least an additional electronic calculator operatively connected to the electronic calculator, the information representative of the CSR policy of a company.

11. The method of claim 10, wherein the step of acquiring information representative of the CSR of a company further comprises a step of sending, by the at least an additional electronic calculator, the information representative of the CSR policy of a company to the electronic calculator.

12. The method of claim 10, wherein the step of entering comprises a step of filling a form, by a user, to be provided to the at least an additional electronic calculator, with the information representative of the CSR policy of the company.

13. Program product loadable in a memory unit of an electronic calculator, the program product being executed by a data processing unit of the electronic calculator to perform steps of:
acquiring information representative of a stakeholder;
generating, on the basis of the information representative of each stakeholder, a map representing the relationships data between the company and its stakeholder, said step of generating further comprises a step of defining on the map a Cartesian graph comprising a first X-axis and a second Y-axis, the first X-Axis of the Cartesian graph being representative of the influence of a stakeholders on the company, the second Y-Axis of the Cartesian graph being representative of the influence of the company on the stakeholders.

14. The program product of claim 13, wherein the program product is executed by the data processing unit of the electronic calculator to perform also, in the step of generating a map, a step of positioning on the map, on the basis of the information representative of each stakeholder, a plurality of icon, each of them being corresponding to a stakeholder.

15. The program product of claim 14, wherein the program product is executed by the data processing unit of the electronic calculator to perform also, in the step of positioning, a step of sizing each icon of the plurality of icon on the basis of information representative of each stakeholder, respectively.

16. The program product of claim 14, wherein the program product is executed by the data processing unit of the electronic calculator to perform also, in the step of positioning, a step of associating to each icon a graphic element corresponding to a level of potential crisis in the relationship between the company and the stakeholder corresponding to said icon.

17. System for representing relationships between a company and its stakeholders, comprising:
an electronic calculator having a data processing unit and a memory unit operatively connected to the data processing unit;
at least an additional electronic calculator operatively connected to the electronic calculator by a communication network,
the electronic calculator being configured to perform the steps of:
acquiring information representative of a stakeholder;
generating, on the basis of the information representative of each stakeholder, a map representing the relationships data between the company and its stakeholder, said step of generating further comprises a step of defining on the map a Cartesian graph comprising a first X-axis and a second Y-axis, the first X-Axis of the Cartesian graph being representative of the influence of a stakeholders on the company, the second Y-Axis of the Cartesian graph being representative of the influence of the company on the stakeholders.
